(19) United States
(12) Patent Application Publication
(10) Pub. No.: US 2013/0027173 A1
(43) Pub. Date: Jan. 31, 2013

(54) TRANSFORMER

(71) Applicant: Takashi Ohsawa, Tokyo (JP)

(72) Inventor: Takashi Ohsawa, Tokyo (JP)

(73) Assignee: MITSUBISHI ELECTRIC CORPORATION, Tokyo (JP)

(21) Appl. No.: 13/639,171

(22) PCT Filed: Jul. 26, 2010
(86) PCT No.: PCT/JP2010/004742

§ 371 Date: Oct. 3, 2012

(51) Int. Cl. H01F 27/28

(52) U.S. Cl. 336/220

(57) ABSTRACT

A columnar leg portion 54 of a first core 50 is inserted into a tubular portion 21 of a second bobbin 20 having a secondary winding 40 wound therearound and including a flange 22 at one end, and the columnar leg portion 54 of the first core 50 and the tubular portion 21 of the second bobbin 20 are inserted into a tubular portion 11 of a first bobbin 10 having a primary winding 30 wound therearound and having a flange 12 at one end, and a leading end 41 as the wind-beginning of the secondary winding 40 is pulled out to the outside of a transformer through the gap between the tubular portions 11 and 21.

### TECHNICAL FIELD

The present invention relates to a high-voltage capable sheet transformer that insulates the primary side from the secondary side.

### BACKGROUND ART

In a trend to reduce emissions of carbon dioxide, a small amount of the emissions from an electric vehicle is accepted, and the electric vehicle starts to be prevalent due to an increasing demand therefor.

A circuit to which a high voltage of, e.g. 400 V, is supplied, not existing in a conventional gasoline engine vehicle, is mounted in the electric vehicle. Heretofore, a high-voltage circuit has been mostly connected to a power source supplied from an AC power line, and in such an application has been increased in efficiency and reduced in size in its own way. However, when the high-voltage circuit is mounted in the electric vehicle, a further increase in efficiency and a further reduction in size are required for the circuit. In particular, a transformer is a large component in a circuitry of a power system, and therefore downsizing of the transformer is required. Conventionally, there exists a sheet transformer of which the winding is formed in a sheet shape as a means for downsizing the transformer; especially, examples of a high-voltage capable sheet transformer are disclosed in Patent Documents 1 and 2 discussed below.

A sheet transformer disclosed in Patent Document 1 is related to a step-up transformer that generates a high voltage for lighting a cold cathode lamp, and guides a lead of a secondary winding for generating a high voltage to a terminal portion through a notch prepared in a core to be separated by a distance from the other winding sections, thereby securing voltage endurance thereof.

A sheet transformer disclosed in Patent Document 2 is related to a transformer that generates a high-voltage igniter pulse for starting a discharge lamp, as filed by the same inventor as that of the present invention; a secondary winding is wound around a bobbin in which a primary winding in a flat plate is buried, and a lead of the secondary winding is axially pulled out with respect to a central core and connected to a terminal to be separated by a distance from the other parts, thereby securing voltage endurance- thereof.

### PRIOR ART DOCUMENTS

### Patent Documents

Patent Document 1: Japanese Unexamined Utility Model Application Publication No. H7-7120

Patent Document 2: WO 2008/53613

### SUMMARY OF THE INVENTION

The aforementioned sheet transformers according to Patent Documents 1 and 2 are based on the assumption that a core having a large electric resistance is used, and therefore Patent Document 1 has a configuration such that the secondary winding comes indirect contact with the core. Patent Document 2 also has a configuration such that the terminal comes in direct contact with the core. As mentioned above, for the purpose of securing the voltage endurance, the conventional one is not a structure such that a stick-like core positioned at the center of the winding or a plate-like core along the winding is separated by a distance from the lead of the secondary winding.

However, since a transformer constituting a high-voltage power circuit handles a large current to emit a strong magnetic field, the transformer cannot help using a core having a small electric resistance inevitably. For this reason, it is necessary to consider an insulation between a winding and a core by means of a configuration such that a sufficient distance or a partition is provided between the winding and the core. Therefore, there is a problem such that as disclosed in Patent Document 1 or 2, the transformer having no structure to be separated by a distance between the winding and the core is inapplicable to the high-voltage power transformer.

The present invention is made to solve the aforementioned problem, and an object of the invention is to provide a sheet type of transformer such that an insulation between a primary winding, a secondary winding, and a core is secured.

A transformer of the present invention is a transformer including: a magnetic member having a plate-like portion, an outer leg portion protrusively provided at a side on a surface of the plate-like portion in a direction orthogonal to the plate-like portion, and a columnar leg portion protrusively provided at a center of the surface of the plate-like portion; a plurality of bobbins each constituting a tubular portion into which the columnar leg portion of the magnetic member is inserted and having a flange at one end of the tubular portion; and a plurality of windings wound around the respective tubular portions of the plurality of bobbins, wherein the tubular portion of one bobbin as apart of the plurality of bobbins has a shape to be inserted into the tubular portion of another bobbin thereof from the side of the flange thereof, and an end of the winding on the side of the tubular portion to be disposed between the bobbin inserting the tubular portion thereinto and the bobbin to be inserted thereinto is pulled out to the outside through a gap between the tubular portions of the bobbin inserting the tubular portion thereinto and the bobbin to be inserted thereinto.

According to the invention, it is possible to provide a sheet transformer that secures the insulation between the primary winding, the secondary winding, and the core, since the insulation between the plate-like portion of the magnetic member and the winding is provided by the flange of the bobbin, the insulation between the windings is provided by the flange of another bobbin, the insulation between the columnar leg portion of the magnetic member and the winding is provided by the tubular portion of the bobbin, and further the end of the winding on the side of the tubular portion is insulated from another winding and the magnetic member by the flange and the tubular portion of the bobbin.

### BRIEF DESCRIPTION OF THE DRAWINGS

FIG. 1 is a perspective view showing a configuration of a transformer according to Embodiment 1 of the present invention.

FIG. 2 is a cross-sectional view of the transformer shown in FIG. 1 taken along a line AA.

FIG. 3 is an exploded perspective view of the transformer shown in FIG. 1.

FIG. 4 is a perspective view showing a configuration of a transformer according to Embodiment 2 of the invention.

FIG. 5 is a cross-sectional view of the transformer shown in FIG. 4 taken along a line BB.

FIG. 6 is an exploded perspective view of the transformer shown in FIG. 4.

FIG. 7 shows a modification of a first core: FIG. 7(a) is a perspective view; and FIG. 7(b) is a cross-sectional view taken along a line DD.

FIG. 8 show a configuration of an elastic member of a transformer according to Embodiment 3 of the invention: FIG. 8(a) is a perspective view of a second bobbin; and FIG. 8(b) is a cross-sectional view taken along a line EE.

FIG. 9 is a perspective view showing a primary winding using a plate-like wire of a transformer according to Embodiment 4 of the invention.

FIG. 10 is a cross-sectional view showing a configuration of a flyback transformer according to Embodiment 6 of the invention.

FIG. 11 is a cross-sectional view showing another example of the flyback transformer according to Embodiment 6 of the invention.

FIG. 12 is a block diagram showing a configuration of a power system of an electric vehicle to which a transformer according to Embodiment 7 of the invention is applied.

### BEST MODE FOR CARRYING OUT THE INVENTION

In the following, in order to explain the present invention in more detail, embodiments of the invention will be described with reference to the accompanying drawings.

### Embodiment 1

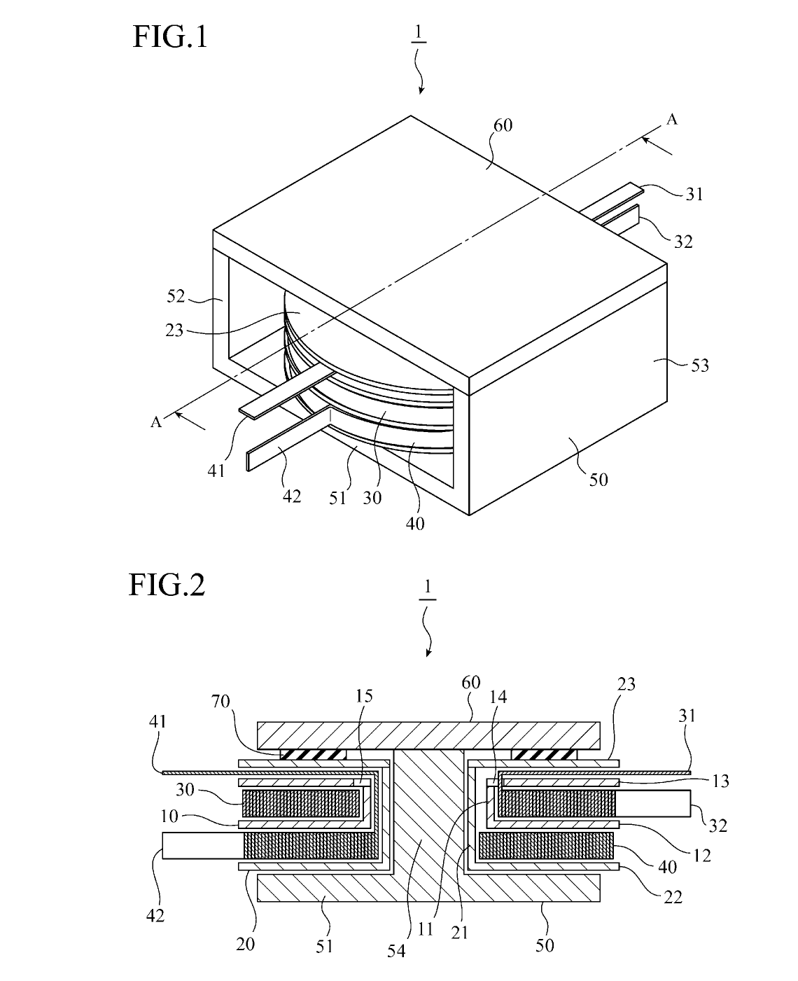

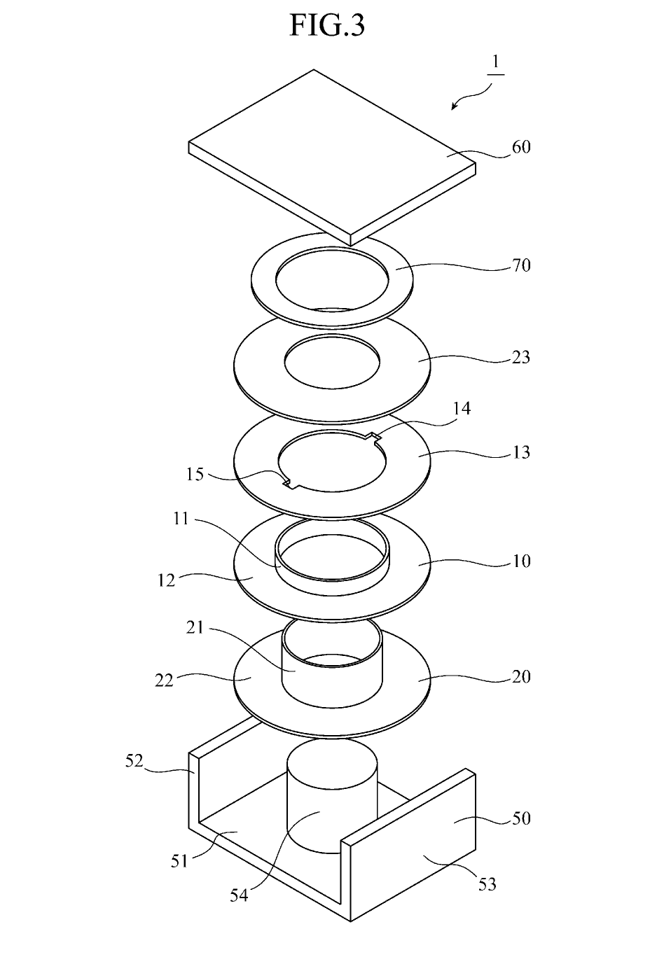

FIG. 1 shows an appearance of a transformer 1 according to Embodiment 1, FIG. 2 shows a cross section taken along a line AA, and FIG. 3 shows an exploded state of components except windings. The transformer 1 is composed of: a first bobbin 10; a sheet-like primary winding (first winding) 30 wound around the first bobbin 10; a second bobbin 20; a sheet-like secondary winding (second winding) 40 wound around the second bobbin 20; a first core (magnetic member) 50 that telescopically holds the first bobbin 10 and the second bobbin 20; a second core (magnetic member) 60 that comes in contact with the first core 50; a first insulating plate 13 that supports the primary winding (first winding) 30 and insulates the primary winding 30 from the other members; a second insulating plate 23 that insulates an end 31 of the primary winding (first winding) 30 and an end 41 of the secondary winding (second winding) 40 from the other members; and an elastic member 70.

The first bobbin 10 and the second bobbin 20 are formed of a resin or the like. The first bobbin 10 includes a tubular portion 11 and a flange 12 formed at one end of the tubular portion 11. The sheet-like primary winding 30 around which a wire is wound in one layer is formed around the tubular portion 11. The second bobbin 20 includes a tubular portion 21 that is smaller in diameter and longer in an axial direction than the tubular portion 11 of the first bobbin 10, and a flange 22 formed at one end of the tubular portion 21. The sheet-like secondary winding 40 around which the wire is wound in one layer is formed around the tubular portion 21. In addition, on the inner edge side of the first insulating plate 13, there are provided a pulling portion 14 for pulling out the leading end 31 as the wind-beginning of the primary winding 30 and a pulling portion 15 for pulling out the leading end 41 as the wind-beginning of the secondary winding 40.

Examples of the wire used in the primary winding 30 and secondary winding 40 include a round wire having a circular cross section, a square wire having a square cross section, and a flat wire having a rectangular cross section. When the flat wire or the square wire like the illustrated example is used, the proportion of the wire occupying the winding space can be increased; thus, there is an advantage that the primary winding 30 and secondary winding 40 can be reduced in size. In addition, in the primary and secondary windings 30 and 40, the leading ends 31 and 41 as the wind-beginnings are located on the central side, while the terminal ends 32 and 42 as the wind-ends are located on the outer edge side to be apart from the central, which enables to secure the voltage endurance between the ends of each winding.

The first core 50 and the second core 60 are formed of a magnetic member. The combination of the first and second cores 50 and 60 is what is called an EIR core, and includes: a plate-like portion 51; a pair of opposing outer leg portions 52 and 53 protrusively provided in a direction orthogonal to the plate-like portion 51; and a columnar leg portion 54 protrusively provided at the center of the plate-like portion 51. The second core 60 is formed in a tabular shape like the illustrated example, and is disposed on the tip side of the columnar leg portion 54 of the first core 50. Alternatively, a core having the same shape as that of the first core 50 may be used instead of the second core 60, and a set of cores may be obtained by combining the two cores corresponding to the first core 50 in such a manner that the tip sides of the columnar leg portions 54 are opposite to each other.

The columnar leg portion 54 of the first core 50 is inserted into the tubular portion 21 of the second bobbin 20 around which the secondary winding 40 is wound, the tubular portion 21 is further inserted into the tubular portion 11 of the first bobbin 10 around which the primary winding 30 is wound, and the first bobbin 10 and the second bobbin 20 are thereby telescopically disposed. Then, the first insulating plate 13 is attached to the tubular portion 11 of the first bobbin 10, the leading end 31 as the wind-beginning of the primary winding 30 and the leading end 41 as the wind-beginning of the secondary winding 40 are pulled out to the outside, and the second insulating plate 23 is attached to the tubular portion 21 of the second bobbin 20. Further, in order to configure the first core 50 as a closed magnetic circuit, the second core 60 is combined with the first core on the tip sides of the outer leg portions 52 and 53 and the columnar leg portion 54.

In such a way, since the primary winding 30 is separated from the secondary winding 40 by the flange 12 of the first bobbin 10, the adjacent windings can be insulated from each other, and the voltage endurance between the windings can be secured. In addition, when the thicknesses of the first and second bobbins 10 and 20 are as thin as possible within a range such that the voltage endurance can be secured, the windings can be arranged close to each other, and therefore it is possible to reduce magnetic flux leakage thereof, which improves the performance of the transformer 1 (coupling of the primary winding 30 and the secondary winding 40 and so on). Further, the secondary winding 40, the first core 50, and the second core 60 are separated from each other by the second bobbin 20 and the second insulating plate 23, which enables to secure the insulation between the winding and the cores.

The leading end 31 of the primary winding 30 is pulled out from the pulling portion 14 of the first insulating plate 13, and is further dragged in a radial direction between the first insulating plate and the second insulating plate 23 to be pulled out from the transformer 1. On the other hand, the leading end 41 of the secondary winding 40 disposed between the flanges 12 and 22 is pulled out from the pulling portion 15 of the first insulating plate 13 through the gap provided between the tubular portion 11 and the tubular portion 21, and is further dragged in the radial direction between the first insulating plate and the second insulating plate 23 to be pulled out from the transformer 1. The terminal end 32 of the primary winding 30 and the terminal end 42 of the secondary winding 40 are pulled out directly from the transformer 1. Note that it is also possible to provide terminals for connecting the leading ends 31 and 41 and the terminal ends 32 and 42 at the flanges of the first bobbin 10 and the second bobbin 20, though the depiction thereof is omitted.

At this point, the direction in which the leading end 31 and the terminal end 32 of the primary winding 30 are pulled out and the direction in which the leading end 41 and the terminal end 42 of the secondary winding 40 are pulled out are set to be symmetric with respect to the axial direction of the columnar leg portion 54, whereby it is possible to increase the intervals between the ends of the windings, which enables to secure the voltage endurance between the ends.

Further, the elastic member 70 may also be disposed between the second insulating plate 23 and the second core 60 such that the primary winding 30 and the secondary winding 40 are pressed toward the plate-like portion 51 of the first core 50. By the pressing, the space between the plate-like portion 51, the primary winding 30, and the secondary winding 40 can be reduced, so that favorable transformer characteristics can be obtained. It is noted that when it is configured that the elastic member 70 is provided with the function of the second insulating plate 23, whereby a direct pressing thereon is carried out by the elastic member 70 with the windings insulated, the reduction of the number of components and downsizing thereof are improved.

Additionally, for the purpose of securing the moisture resistance, voltage endurance and so on, the transformer 1 is finally impregnated with a resin (varnish and so on). By virtue of this process, since the resin fixes the first bobbin 10, the second bobbin 20, the primary winding 30, the secondary winding 40, the first core 50, and the second core 60, the elastic member 70 may simply exert an effect as a temporarily positioning member. Therefore, an elastic force on a temporarily holding level is sufficient for the elastic member 70, and a continuous elastic force is not required therefor. Incidentally, the elastic member 70 may have any shape; for example, one doughnut-shaped elastic member 70 may be provided as shown in FIG. 3, or three or more elastic members 70 may also be arranged at regular intervals on the second insulating plate 23.

Furthermore, it may be configured that the first bobbin 10, the second bobbin 20, the first core 50, or the second core 60 is provided with a fixing member (not shown), and that the transformer 1 is fixed to an equipment by the fixing member.

With the foregoing arrangement, the transformer 1 according to Embodiment 1 is configured to include: the first bobbin 10 having the tubular portion 11 and the flange 12 formed at one opening end of the tubular portion 11; the first insulating plate 13 provided at the other opening of the first bobbin 10 and opposing the flange 12 of the first bobbin 10; the second bobbin 20 having the tubular portion 21 smaller in diameter and longer in the axial direction than the tubular portion 11 of the first bobbin 10, and the flange 22 formed at one opening end of the tubular portion 21; the first core 50 that has the plate-like portion 51, the pair of opposing outer leg portions 52 and 53 protrusively provided in the direction orthogonal to the plate-like portion 51, and the columnar leg portion 54 protrusively provided at the center of the plate-like portion 51, and that telescopically holds the tubular portion 21 of the second bobbin 20, the tubular portion 11 of the first bobbin 10, and the first insulating plate 13 into which the columnar leg portion 54 are inserted in order; the tabular second core 60 that is combined with the first core 50 on the tip sides of the columnar leg portion 54 and the outer leg portions 52 and 53; the primary winding 30 which has the shape of a sheet wound around the tubular portion 11 of the first bobbin 10 and of which both sides are supported by the flange 12 of the first bobbin 10 and the first insulating plate 13; and the secondary winding 40 which has the shape of a sheet wound around the tubular portion 21 of the second bobbin which is not inserted into the tubular portion of the first bobbin and of which both sides are supported by the flange 22 of the second bobbin 20 and the flange 12 of the first bobbin 10. Therefore, it becomes possible to dispose the wind-beginning and the wind-end of each winding at positions spaced apart from each other (central side and outer edge side), which enables to secure the voltage endurance between the ends of the windings. In addition, the plate-like portion of the core and the windings can be isolated and insulated from each other by the flanges of the bobbins and the insulating plates. Further, the columnar leg portion of the core and the windings can be isolated and insulated from each other by the tubular portions of the bobbins.

In addition, it is configured that the leading end 31 of the primary winding 30 is pulled out from the pulling portion 14 provided in an open manner in the first insulating plate 13 into the gap between the first insulating plate 13 and the second insulating plate 23, and that the leading end 41 of the secondary winding 40 is pulled out from the pulling portion 15 provided in an open manner in the first insulating plate 13 into the gap between the first insulating plate 13 and the second insulating plate 23 with passing through the gap between the tubular portions 11 and 21 of the first and second bobbins 10 and 20. Therefore, it becomes possible to pull out the end as the wind-beginning through the space between the bobbins; thus, the end as the wind-beginning can be isolated and insulated from the other winding and the cores by the flanges and the tubular portions of the bobbins and the insulating plates.

Thus, it is possible to provide a sheet type of transformer in which the insulation between the primary winding, the secondary winding, and the cores is secured. Also, since the windings can be arranged close to each other by reducing the thicknesses of the flanges of the bobbins that serve to insulate the windings from each other, it is possible to reduce magnetic flux leakage thereof, which enables to improve the performance of the transformer.

Further, according to Embodiment 1, since the direction in which the leading end 31 and the terminal end 32 of the primary winding 30 are pulled out, and the direction in which the leading end 41 and the terminal end 42 of the secondary winding 40 are pulled out are set to be symmetric with respect to the axial direction of the columnar leg portion 54 of the first core 50, it is possible to increase the interval between the ends of both windings, which enables to secure the voltage endurance between the ends.

Furthermore, according to Embodiment 1, since the transformer 1 is configured to include the elastic member 70 serving to press the primary winding 30 and the secondary winding 40 toward the plate-like portion 51 of the first core 50, it is possible to reduce the space between the cores and the windings, which enables to obtain favorable characteristics of the transformer.

Moreover, according to Embodiment 1, since the flat wire is employed in the primary winding 30 and the secondary winding 40, the space factor of the winding is increased to reduce useless spaces, thereby downsizing the transformer.

Note that it is also possible to configure a choke coil by using the core and the bobbin of the transformer 1 according to Embodiment 1 described above.

### Embodiment 2

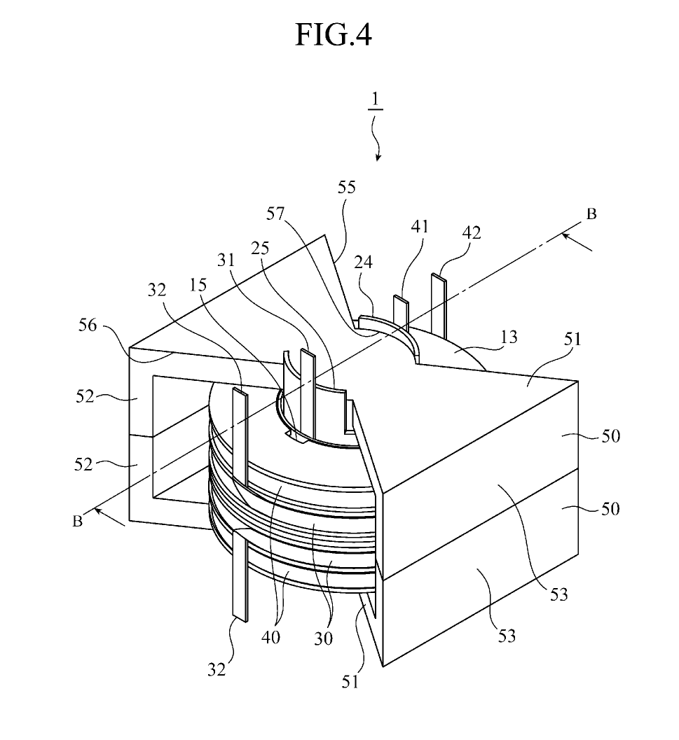

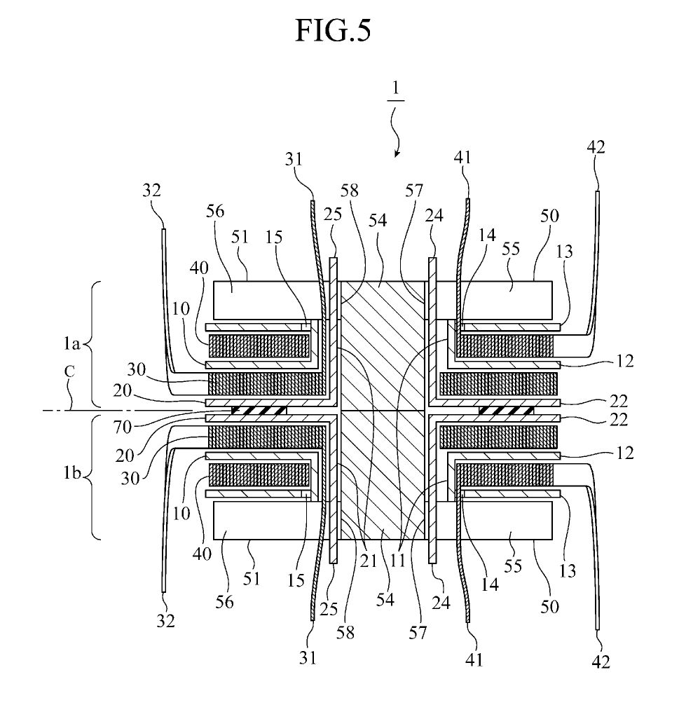

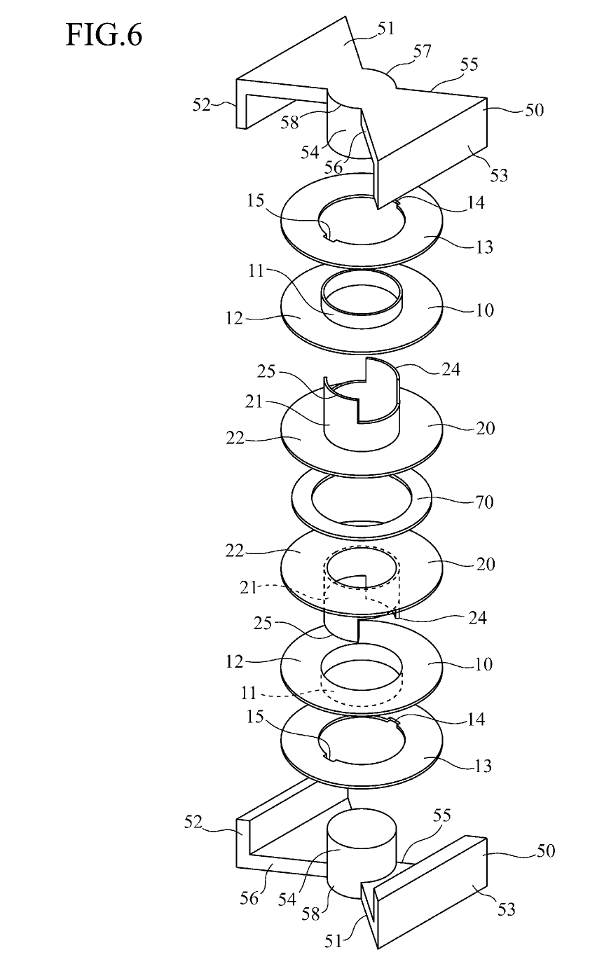

FIG. 4 shows an appearance of a transformer 1 according to Embodiment 2, FIG. 5 shows a cross section taken along a line BB, and FIG. 6 shows an exploded state of components except windings. In FIGS. 4 to 6, parts which are the same as or equivalent to those in FIGS. 1 to 3 are designated by the same reference numerals. The transformer 1 according to Embodiment 2 includes transformers 1a and 1b each having a first core (magnetic member) 50 that telescopically holds a first bobbin 10 around which a secondary winding (first winding) 40 is wound and a second bobbin 20 around which a primary winding (second winding) 30 is wound, and the transformer is configured by joining the transformers 1a and 1b together such that the first cores 50 face each other. Note that two pairs of the primary winding 30 and the secondary winding 40 are disposed to be symmetric with respect to an opposing plane C.

The first core 50 is what is called a PQ core; notches 55 and 56 are formed by notching a pair of opposing sides of the plate-like portion 51, and the peripheral surface of a columnar leg portion 54 is extended to the plate-like portion. Such extended surfaces 57 and 58 are disposed to be symmetric with respect to the axial direction of the columnar leg portion 54.

The second bobbin 20 includes a tubular portion 21 and a flange 22 formed at one end of the tubular portion 21. In addition, extended portions 24 and 25 is formed in the second bobbin 20 such that part of the end on the flange-less side of the tubular portion 21 is extended. The extended portions 24 and 25 cover the extended surfaces 57 and 58 by extending the peripheral surface of the columnar leg portion 54 to the plate-like portion, and serve as partitions for insulating leading ends 31 and 41 from the first core 50.

The leading end 41 of the secondary winding 40 is pulled out from the pulling portion 14 provided in an open manner in the insulating plate portion 13 to the extended portion 24. The leading end 31 of the primary winding 30 is passed through the gap provided between the tubular portions 11 and 21 in the axial direction and is pulled out from the pulling portion 15 provided in an open manner in the insulating plate portion 13 to the extended portion 25. The terminal end 32 of the primary winding 30 and the terminal end 42 of the secondary winding 40 are directly pulled out from the transformer 1.

At this point, the direction in which the leading end 31 and the terminal end 32 of the primary winding 30 are pulled out together, and the direction in which the leading end 41 and the terminal end 42 of the secondary winding 40 are pulled out are set to be symmetric with respect to the axial direction of the columnar leg portion 54, and it is thereby possible to expand the interval between the ends of each winding, which enables to secure the voltage endurance between the ends. In addition, since the leading ends 31 and 41, and the extended surfaces 57 and 58 extending the peripheral surface of the columnar leg portion 54 of the first core 50 to the plate-like portion are partitioned by the extended portions 24 and 25 of the second bobbin 20, the insulation between the windings and the core can be secured.

An elastic member 70 is disposed between the two pairs of telescopic structures, i.e., between the flanges 22 on the sides of the transformers 1a, 1b. In this way, the two pairs of windings each can be pressed toward the plate-like portion 51 of the corresponding first core 50, and therefore the positional relationship among the plate-like portion 51, the primary winding 30, and the secondary winding 40 becomes equal in each of the transformers 1a, 1b, and also the characteristics thereof also become equal therein. In such a way, the loads of the transformers 1a, 1b can be equalized; without concentration of the load on one of the transformers, it can be avoided that only part of them is biasedly put at a high temperature. For this reason, it is possible to cause the transformer 1 to operate without giving a local stress to the transformer 1, which enables to enhance the reliability as the transformer.

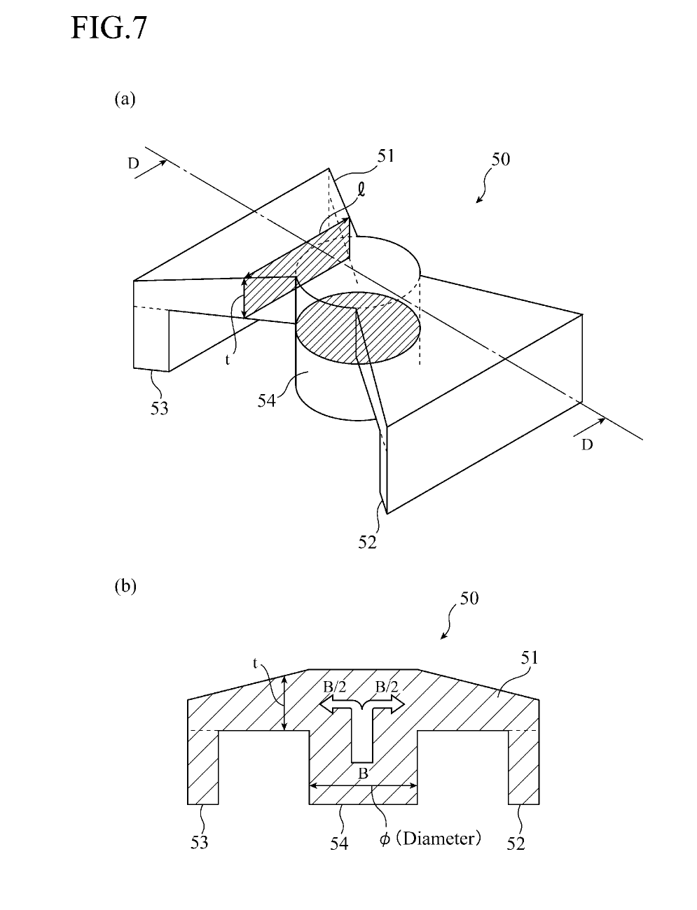

FIGS. 7 show a modification of the first core 50: FIG. 7(a) is a perspective view thereof; and FIG. 7(b) is a cross-sectional view thereof taken along a line DD. In the plate-like portion 51 of the first core 50, the central portion provided with the columnar leg portion 54 is thicker, while both end portions provided with the outer leg portions 52 and 53 are thinner. A magnetic flux B emitted by the primary winding 30 passes through the columnar leg portion 54 in the axial direction, and the magnetic flux B/2 reaches each end portion of the plate-like portion 51 via the central portion thereof. At this point, when the cross-sectional area at each position of the plate-like portion 51 is not less than ½ of the cross-sectional area of the columnar leg portion, the magnetic flux is not hindered, and when the product of a width 1 and a thickness t of each position of the plate-like portion 51 is the same level as ½ of the cross-sectional area of the columnar leg portion, there is no problem in terms of the characteristics of the transformer. Accordingly, in the case of the first core 50, since the width 1 of the plate-like portion 51 is gradually expanded from the side of the columnar leg portion 54 toward the outer leg portions 52 and 53, the characteristics of the transformer are not effected even when the thickness t is reduced as the width is expanded. Thus, since the plate-like portion 51 opposing the winding can be formed with an appropriate, right amount of the magnetic material at each position of the first core 50, the weight of the core can be reduced without degrading the performance of the transformer.

With the foregoing arrangement, the transformer 1 according to Embodiment 2 is configured to include: the first bobbin 10 having the tubular portion 11 and the flange 12 formed at one opening end of the tubular portion 11; the first insulating plate 13 provided at the other opening of the first bobbin 10 and opposing the flange 12 of the first bobbin 10; the second bobbin 20 having the tubular portion 21 smaller in diameter and longer in the axial direction than the tubular portion 11 of the first bobbin 10, the flange 22 formed at one end of the tubular portion 21, and the extended portions 24 and 25 extending a part of the other end of the tubular portion 21; the first core 50 formed of the magnetic member that is provided with the plate-like portion 51, the pair of opposing outer leg portions 52 and 53 protrusively provided in the direction orthogonal to the plate-like portion 51, the columnar leg portion 54 protrusively provided at the center of the plate-like portion 51, and the surfaces 57 and 58 by notching the sides of the plate-like portion 51 and extending a part of the peripheral surface of the columnar leg portion 54, and that telescopically holds the tubular portion 21 of the second bobbin 20 and the tubular portion 11 of the first bobbin 10 into which the columnar leg portion 54 is inserted in order, and has the surfaces 57 and 58 extending a part of the peripheral surface of the columnar leg portion 54 covered with the extended portions 24 and 25 of the second bobbin 20; the secondary winding 40 which has the shape of a sheet wound around the tubular portion 11 of the first bobbin 10 and of which both sides are supported by the flange 12 of the first bobbin 10 and the first insulating plate 13; and the primary winding 30 which has the shape of a sheet wound around the tubular portion 21 of the second bobbin 20 which is not inserted into the tubular portion 11 of the first bobbin 10 and of which both sides are supported by the flange 22 of the second bobbin 20 and the flange 12 of the first bobbin 10, wherein the end 41 on the side of the tubular portion of the secondary winding 40 is pulled out from the one pulling portion 14 provided in an open manner in the first insulating plate 13 toward the one notch 57 of the first core 50, and the end 31 on the side of the tubular portion of the primary winding 30 is passed through the gap between the tubular portions 11 and 21 of the first and second bobbins 10 and 20 which are fitted to each other and is pulled out from the other pulling portion 15 provided in an open manner in the first insulating plate 13 toward the other notch 58 of the first core 50. Therefore, similarly to Embodiment 1 described above, the plate-like portion of the core and the windings can be isolated and insulated from each other by the flanges of the bobbins and the insulating plates, and the columnar leg portion of the core and the windings can be isolated and insulated from each other by the tubular portions of the bobbins. Consequently, it becomes possible to dispose the wind-beginning and the wind-end of each winding at positions spaced apart from each other (central side and outer edge side), which enables to secure the voltage endurance between the ends of the windings.

In addition, it is configured that the leading end 41 of the secondary winding 40 is pulled out from the pulling portion 14 provided in an open manner in the first insulating plate 13 toward the notch 57 of the first core 50 (the surface extending a part of the peripheral surface of the columnar leg portion), and that the leading end 31 of the primary winding 30 is passed through the gap between the tubular portions 11 and 21 of the first and second bobbins 10 and 20, and is pulled out from the pulling portion 15 provided in an open manner in the first insulating plate 13 toward the notch 58 of the first core 50 (the surface extending a part of the peripheral surface of the columnar leg portion). For this reason, it becomes possible to pull out the leading end of each winding to the outside of the transformer without causing the leading end to pass through the space between the flanges of the bobbins; thus, the space between the core and the winding can be reduced and the core and the winding can be brought close to each other, and therefore it is possible to reduce magnetic flux leakage thereof, which enables to improve the performance of the transformer. In addition, the end as the wind-beginning of the winding can be isolated and insulated from the other winding and the cores by the insulating plates and the extended portions, the flanges, and the tubular portions of the bobbins.

Consequently, similarly to Embodiment 1 described above, it is possible to provide the sheet type of transformer in which the insulation between the primary winding, the secondary winding, and the cores is secured. In addition, since it is possible to reduce the thickness of the flange of the bobbin for insulating the windings from each other to arrange the windings close to each other, the magnetic flux leakage can be reduced, thereby improving the performance of the transformer.

In addition, according to Embodiment 2, since the direction in which the leading end 31 and the terminal end 32 of the primary winding 30 are pulled out, and the direction in which the leading end 41 and the terminal end 42 of the secondary winding 40 are pulled out are set to be symmetric with respect to the axial direction of the columnar leg portion 54 of the first core 50, it is possible to expand the interval between the ends of both windings, which enables to secure the voltage endurance between the ends.

Further, according to Embodiment 2, it is configured that the transformer 1 includes the two pairs of transformers 1a and 1b each having the first core 50 that telescopically holds the first and second bobbins 10 and 20 as a set of transformers, and that the tip surfaces of the columnar leg portions 54 of the two pairs of the first cores 50 are opposite to each other, and the primary windings 30 and the secondary windings 40 are disposed to be symmetric with respect to the opposing plane C. For this reason, the characteristics of the transformer 1a and the transformer 1b become equal to each other, thereby facilitating a parallel connection of the windings. Accordingly, when the two primary windings 30 are connected in parallel and also the two secondary windings 40 are connected in parallel, whereby the cross-sectional area of each wire is doubled, a flowing current therethrough can be doubled.

Furthermore, when the two primary windings 30 are connected in series and also the two secondary windings 40 are connected in series, whereby the number of turns of each wire is doubled, the degrees of freedom in the number of turns and in turn ratio can be increased to thus improve the characterisLics (coupling and the like) of the transformer.

Moreover, according to Embodiment 2, since it is configured such that the transformer 1 includes the elastic member 70 that presses two pairs of the primary winding 30 and the secondary winding 40 toward the plate-like portions 51 of the first cores 50, it is possible to reduce the space between the cores and the windings, which enables to obtain favorable characteristics (coupling and the like) of the transformer.

It is noted that one transformer may also be configured by combining the two transformers 1 illustrated in Embodiment 1 described above. In this instance, the second core 60 is not combined with the first core 50, but the two first cores 50 are combined with each other. More specifically, the two first cores 50 each telescopically holding the first and second bobbins 10 and 20 are opposite to each other and brought into contact with each other, and the elastic member 70 is disposed between the opposing second insulating plates 23. Even in the instance of such a configuration, when the two primary windings 30 are connected in parallel and also the two secondary windings 40 are connected in parallel, whereby the cross-sectional area of each wire is doubled, a flowing current therethrough can be doubled. Alternatively, when the two primary windings 30 are connected in series and also the two secondary windings 40 are connected in series, whereby the number of turns of each wire is doubled, the degrees of freedom in the number of turns and in turn ratio can be increased to thus improve the characteristics (coupling and the like) of the transformer.

Note that in Embodiment 2 described above, although the one transformer 1 is configured by combining the transformers 1a and 1b each using the notched core, it is also possible to configure the transformer 1 by only one of the transformers 1a and 1b with one pair of windings. In this instance, in order to construct the core as a closed magnetic circuit, for example, the first core 50 of the transformer 1a may be brought into contact with a PQ core having the same shape, or may be brought into contact with a tabular second core 60 as shown in FIGS. 1 to 3.

### Embodiment 3

Although the above Embodiments 1 and 2 have the configuration in which the separate elastic member 70 is used, the elastic member may also be formed integrally with the bobbin as illustrated in the present Embodiment 3.

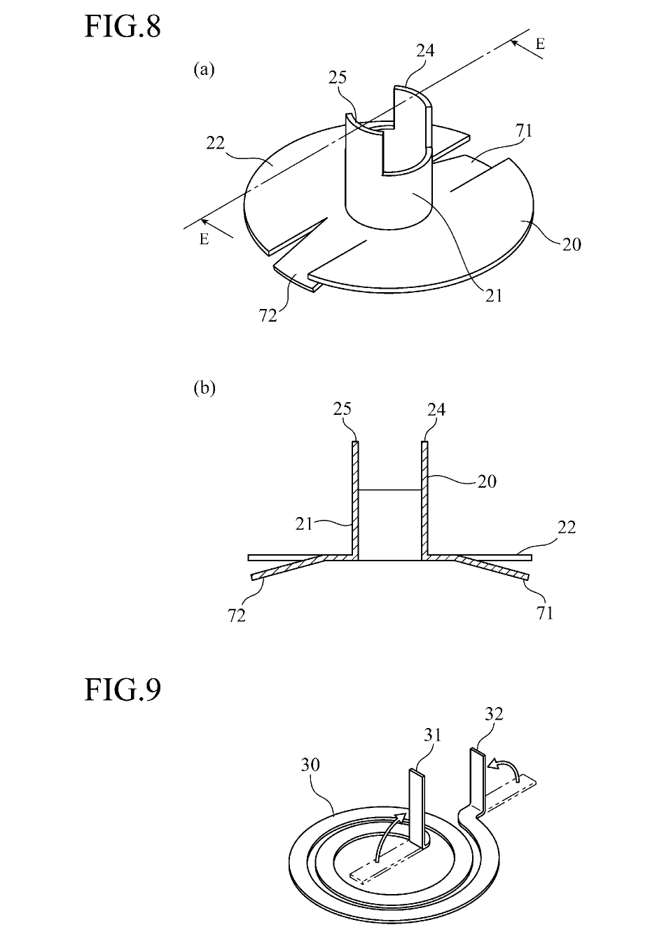

FIG. 8 shows a configuration of elastic members 71 and 72 of a transformer according to Embodiment 3: FIG. 8(a) is a perspective view of a second bobbin 20, and FIG. 8(b) is a cross-sectional view thereof taken along a line EE. It is noted that since the transformer of the present Embodiment 3 has the same configuration as that of the transformer 1 shown in FIGS. 4 to 6 except the configuration of the elastic member, a description is given hereinbelow with reference to FIGS. 4 to 6.

The elastic members 71 and 72 are flat spring-like protrusions, and formed by lancing of the flange 22 of the second bobbin 20. By the flat spring-like elastic members 71 and 72, the second bobbin 20 itself and the other second bobbin 20 facing each other and coming in contact with each other are pressed toward the first core 50. When a part of the flange 22 of the second bobbin 20 is cut open, an opening from which the primary winding 30 is exposed is formed at the cut portion; however, since the same primary winding 30 is wound around the other second bobbin 20 facing each other and coming in contact with each other, both of the primary windings are placed at the same potential, so that no electrical problem occurs. In addition, as mentioned above, since the transformer 1 is finally impregnated with the resin, an elastic force on a temporarily holding level is sufficient for the elastic members 71 and 72, and a continuous elastic force is not required therefor.

Incidentally, also in the transformer 1 according to Embodiment 1 described above, the elastic members 71 and 72 may also be formed in the second insulating plate 23 instead of the elastic member 70.

As mentioned above, according to Embodiment 3, since the elastic members 71 and 72 are provided by the protrusions formed in the flange 22 of the second bobbin 20, it is possible to omit the member used only for pressing each winding toward the plate-like portion of the core, resulting in a simplified working thereof, and thereby lowering the cost.

### Embodiment 4

Although Embodiments 1 and 2 described above have the configuration such that the flat wire is used as the wires of the primary winding 30 and the secondary winding 40, as described in the present Embodiment 4, a wire having another shape may also be used.

For example, a wire rod in which a plurality of wires are bundled (litz wire) or a wire rod in which a plurality of wires are arranged in parallel may also be used in the primary winding 30 and the secondary winding 40. In this instance, it is possible to reduce a loss due to skin effects, and therefore it is possible to reduce a loss during an energization with a high frequency, which enables to increase the operation frequency of the transformer.

In this way, it becomes possible to reduce the number of turns of the winding, which enables to downsize the transformer.

Alternatively, a conductive flat plate, e.g., a plate-like wire formed in a spiral shape may also be used in the primary winding 30 and the secondary winding 40. FIG. 9 is a perspective view showing a primary winding 30 using a plate-like wire. The spiral plate material can be easily formed by, e.g., a punching process. On the other hand, the ends are bent to a predetermined pulling direction to form a leading end 31 and a terminal end 32. The secondary winding 40 can also be formed in the same manner, though the depiction thereof is omitted.

When such a plate material cut out in the spiral shape is employed, it becomes possible to reduce the number of wires wound in parallel in order to increase the cross-sectional area of the winding, so that the transformer can be downsized. It is noted that when a thick plate material is employed, it is possible to increase the cross-sectional area of the winding to allow the passage of a large current, so that a transformer for high power can be constructed.

### Embodiment 5

As shown in FIGS. 1 to 7, the secondary winding 40 is disposed on the side of the plate-like portion 51 of the first core 50, and the transformer 1 is used as a forward transformer.

The following (1) to (4) describe the outline of a current passing through the primary winding, a magnetic flux to be generated, and a current passing through the secondary winding of the forward transformer:

(1) a current is passed through the primary winding 30;

(2) a magnetic field is generated in the vicinity of the primary winding 30 in response to the passage of the current through the primary winding 30;

(3) a current in a direction that emits a magnetic flux canceling a magnetic flux emitted by the primary winding 30 is passed through the secondary winding 40; and

(4) the magnetic flux emitted by the primary winding 30 is balanced with the magnetic flux emitted by the secondary winding 40.

Consequently, the magnitude of the current passing through the primary winding 30 is determined by the magnitude of the current passing through the secondary winding 40.

As the above (3), since the magnetic fluxes emitted by the primary winding 30 and the secondary winding 40 cancel each other in the forward transformer, the large magnetic flux emitted by the primary winding 30 is not leaked to the outside. Therefore, the large magnetic flux does not reach even the first core 50, so that the first core 50 is less likely to be magnetically saturated. Therefore, it is possible to use the first core 50 and the second core 60 having a small cross-sectional area.

As described above, when the transformer 1 is used as the forward transformer, electric energy is transmitted from the primary winding 30 to the secondary winding 40 via the magnetic fields emitted by the primary winding 30 and the secondary winding 40; thus, as shown in FIG. 5, in order not to inhibit the magnetic fluxes of the two windings, the following arrangement is preferable: the primary windings 30 are disposed in the center, the secondary windings 40 are disposed on both sides of the primary windings 30, and the first cores 50 are further disposed outside the secondary windings 40.

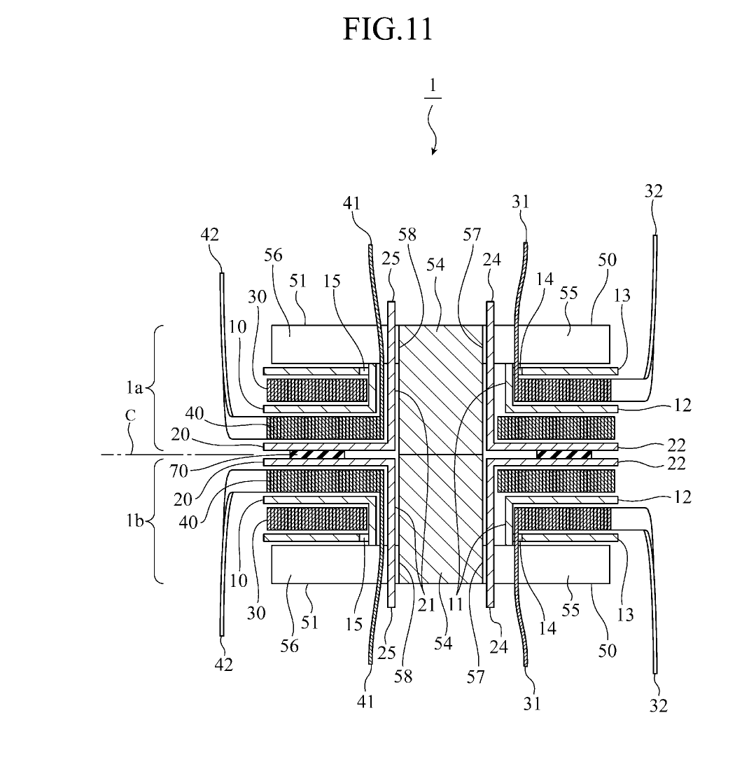

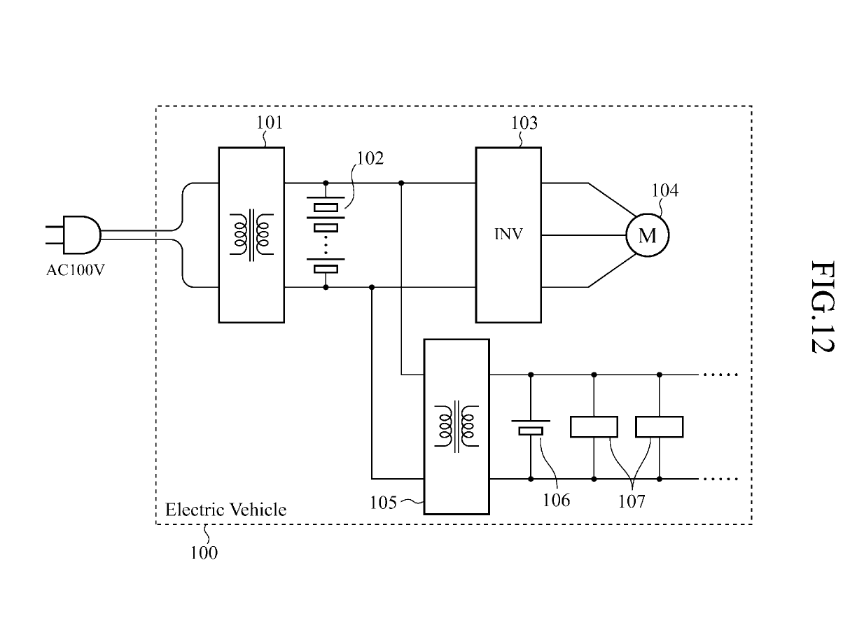

In contract to this, when the primary winding 30 is disposed on the side of the plate-like portion 51 of the first core 50, so that the positional relationship between the primary winding 30 and the secondary winding 40 shown in FIG. 5 is inverted (see the configuration of a flyback transformer of FIG. 11), the magnetic flux that is emitted by the primary winding 30 toward the plate-like portion 51 of the first core 50 becomes less likely to be cancelled by the magnetic flux emitted by the secondary winding 40. Therefore, the magnetic flux emitted by the primary winding 30 toward the plate-like portion 51 of the first core 50 passes through the first core 50, so that magnetic saturation occurs in the first core 50 having a small cross-sectional area; thus, preferable characteristics thereof cannot be expected.

With the foregoing arrangement, according to Embodiment 5, since the transformer 1 is used as the forward transformer such that the secondary winding 40 is disposed on the side of the plate-like portion 51 of the first core 50, the magnetic flux flowing into the core is reduced by an arrangement of the secondary winding between the primary winding and the core, and thereby the cross-sectional area of the core can be reduced. Thus, it is possible to construct a compact transformer.

### Embodiment 6

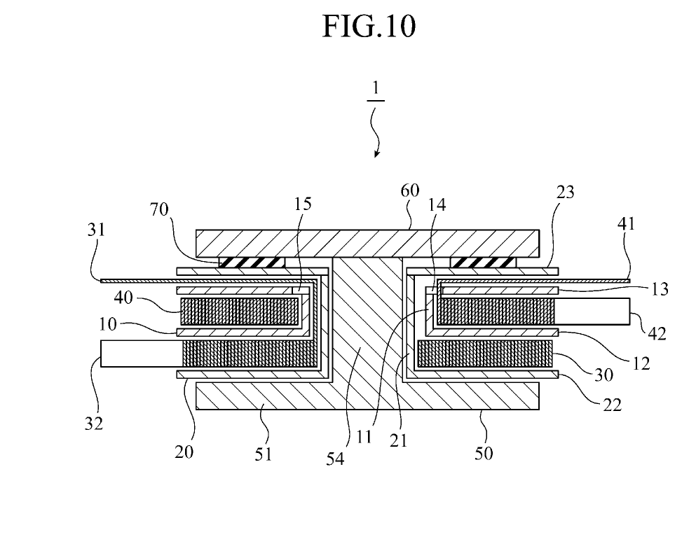

Conversely to Embodiment 5 described above, the primary winding 30 is disposed on the side of the plate-like portion 51 of the first core 50, and the transformer 1 is used as a flyback transformer. FIGS. 10 and 11 are cross-sectional views of the flyback transformer configured such that the positional relationship between the primary winding 30 and the secondary winding 40 of the transformer 1 shown in FIGS. 2 and 5 is inverted.

The following (1) to (5) describe the outline of a current passing through the primary winding, a magnetic flux to be generated, and a current passing through the secondary winding of the flyback transformer:

(1) a current is passed through the primary winding 30;

(2) a magnetic field is generated in the vicinity of the primary winding 30 in response to the passage of the current through the primary winding 30;

(3) the magnetic flux emitted by the primary winding 30 is stored as magnetic energy in the first core 50;

(4) the passage of the current through the primary winding 30 is stopped; and

(5) the magnetic energy stored in the first core 50 develops as electric energy in the primary winding 30 and the secondary winding 40.

In the flyback transformer, the transmission of energy (electric power) is performed when the electric energy developing in (5) mentioned above is extracted.

According to the above (3), the electric energy having flown into the primary winding 30 is temporarily stored as the magnetic energy in the first core 50, and therefore the first core 50 needs to have a cross-sectional area sufficient enough to retain the magnetic energy.

In addition, when the primary winding 30 is disposed in the vicinity of the first core 50 to narrow the gap, the magnetic flux emitted by the primary winding 30 is less likely to be leaked and a large amount of the magnetic flux can be flown into the first core 50; thus, it is possible to efficiently store the magnetic flux emitted by the primary winding 30 in the first core 50 as the magnetic energy, which improves the characteristics of the transformer 1.

In contrast to this, as shown in FIG. 5 (the configuration of the forward transformer), in the configuration in which the secondary winding 40 is disposed between the primary winding 30 and the first core 50, a part of the magnetic flux emitted by the primary winding 30 is cancelled by a forward current of the secondary winding 40 that flows via a stray capacitance, and a part of the magnetic flux does not reach the first core 50 and cannot be stored as the magnetic energy; thus, preferable characteristics thereof cannot be expected.

With the foregoing arrangement, according to Embodiment 6, since the transformer 1 is used as the flyback transformer such that the primary winding 30 is disposed on the side of the plate-like portion 51 of the first core 50, the core can efficiently store the power supplied to the primary winding as the magnetic energy, which enables to improve the characteristics of the transformer.

### Embodiment 7

FIG. 12 is a block diagram showing the configuration of a power system of an electric vehicle 100. The electric vehicle 100 provided with a main battery 102 and a motor 104 includes: a charger 101 that supplies electric power to the main battery 102 from an AC power supply; an inverter 103 that supplies the electric power to the motor 104 from the main battery 102; and a step-down converter 105 that charges a sub-battery 106 from the main battery 102 and supplies the electric power to vehicle-mounted electrical components 107.

In the transformer 1 shown in Embodiments 1 to 6 described above, since the insulation between the primary winding, the secondary winding, and the core is secured, and also a reduction in size and an increase in efficiency are schemed, the transformer 1 is suitable for use in an AC/DC converter (charger 101) which is provided between the AC power supply and the main battery 102 and insulates the AC power supply from the electric vehicle, and a DC/DC converter (step-down converter) which is provided between the main battery 102 and the sub-battery and insulates the batteries from each other.

### INDUSTRIAL APPLICABILITY

As described above, in the transformer according to the present invention, since the sheet-like primary winding and secondary winding are used and the insulation between the windings and the core is secured, the transformer is suitable for use in a charger for a battery for electric vehicle which requires a reduction in size and an increase in efficiency, a step-down converter which generates a voltage supplied to a vehicle-mounted electrical component and so on.

1. A transformer comprising:
a magnetic member including a plate-like portion, an outer leg portion protrusively provided at a side on a surface of the plate-like portion in a direction orthogonal to the plate-like portion, and a columnar leg portion protrusively provided at a center of the surface of the plate-like portion;
a plurality of bobbins each constituting a tubular portion into which the columnar leg portion of the magnetic member is inserted and having a flange at one end of the tubular portion; and
a plurality of windings wound around the respective tubular portions of the plurality of bobbins,
wherein the tubular portion of one bobbin as a part of the plurality of bobbins has a shape to be inserted into the tubular portion of another bobbin thereof from the side of the flange thereof, and
the winding is formed in a spiral shape having an end on the side of the circumference thereof and an end on the side of the tubular portion, and the end of the winding on the side of the tubular portion to be disposed between the bobbin inserting the tubular portion thereinto and the bobbin to be inserted thereinto is pulled out to the outside through a gap between the tubular portions of the bobbin inserting the tubular portion thereinto and the bobbin to be inserted thereinto.

2. The transformer according to claim 1, wherein a notch is provided at a position in contact with the columnar leg portion of the plate-like portion of the magnetic member, and
in the tubular portion of the one bobbin as a part having the flange at the one end, an extended portion covering the notch of the magnetic member is provided at the other end of the tubular portion.

3. The transformer according to claim 1, wherein a notch of the magnetic member is provided at two places in a direction symmetric with respect to an axial direction of the columnar leg portion of the magnetic member.

4. The transformer according to claim 1, further comprising a plate-like magnetic member that comes in contact with tips of the columnar leg portion and the outer leg portion of the magnetic member.

5. The transformer according to claim 1, comprising two sets of the magnetic member, the plurality of bobbins, and the plurality of windings,
wherein between the two sets, tips of the columnar leg portions of the magnetic members are brought into contact with each other, tips of the outer leg portions of the magnetic members are brought into contact with each other, and the windings are disposed to be symmetric with respect to a contact surface thereof

6. The transformer according to claim 1, further comprising an elastic member for pressing the windings toward the plate-like portion of the magnetic member.

7. The transformer according to claim 6, wherein the elastic member is a protrusion formed at the flange of the bobbin.

8. The transformer according to claim 1, wherein a part of the plurality of windings is one pair of a primary winding and a secondary winding.

9. The transformer according to claim 8, wherein an end of the primary winding and an end of the secondary winding are pulled out in an opposite direction with respect to an axial direction of the columnar leg portion of the magnetic member.

10. The transformer according to claim 8, wherein a square wire or a flat wire is used in at least one of the plurality of windings.

11. The transformer according to claim 8, wherein a wire rod in which a plurality of wires are bundled is used in at least one of the plurality of windings.

12. The transformer according to claim 8, wherein a plate-like wire forming a conductive flat plate in a spiral shape is used in at least one of the plurality of windings.

13. The transformer according to claim 8, wherein the secondary winding is disposed on the side of the plate-like portion of the magnetic member to construct a forward transformer.

14. The transformer according to claim 8, wherein the primary winding is disposed on the side of the plate-like portion of the magnetic member to construct a flyback transformer.

15. The transformer according to claim 1, wherein the transformer is used in a vehicle-mounted equipment.
